(19) United States
(12) Patent Application Publication
(10) Pub. No.: US 2008/0253126 A1
(43) Pub. Date: Oct. 16, 2008

(54) Discharge lamp assembly including controller unit

(75) Inventor: Toshiyuki Mizutani, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 12/001,754

(22) Filed: Dec. 12, 2007

(30) Foreign Application Priority Data
Jan. 11, 2007 (JP) 2007-003921

(51) Int. Cl. F21V 29/02; F21V 29/00

(52) U.S. Cl. 362/294; 362/373

(57) ABSTRACT

A discharge lamp assembly according to the present invention is advantageously used as a headlamp of an automotive vehicle. A discharge bulb, a starting circuit for initiating operation of the discharge bulb, and a controller for controlling operation of the discharge bulb are contained in a lamp housing. The lamp housing is composed of a front cover including a front lens, and a back cover. The back cover having a heat-dissipating structure such as an open window is detachably connected to the front cover. The controller unit is mounted directly on a fringe portion of the open window so that heat in the controller unit is effectively dissipated. A heat-dissipating plate, to which the controller unit is connected, and heat-dissipating fins may be additionally disposed at the window to further improve heat dissipation from the controller unit.

### CROSS-REFERENCE TO RELATED APPLICATION

This application is based upon and claims benefit of priority of Japanese Patent Application No. 2007-3921 filed on Jan. 11, 2007, the content of which is incorporated herein by reference.

### BACKGROUND OF THE INVENTION

1. Field of the Invention

The present invention relates to a discharge lamp assembly including a controller unit, which is advantageously used in an automotive vehicle.

2. Description of Related Art

An example of a discharge lamp device is disclosed in JP-A-10-147174. In this device, a high voltage discharge bulb and a controller are contained in a lamp casing. The controller is contained in a controller casing composed of a resin casing and a metallic casing. The resin casing intercepts heat from the discharge bulb and protects circuits contained therein, and the metallic casing is disposed at a position where heat generated therein is easily radiated outside.

However, a problem is involved in this conventional device. That is, the controller casing becomes large in size because it includes the resin casing and the metallic casing.

### SUMMARY OF THE INVENTION

The present invention has been made in view of the above-mentioned problem, and an object of the present invention is to provide a compact discharge lamp assembly, in which heat is well dissipated to an outside space.

The discharge lamp assembly according to the present invention is advantageously used as a headlamp for an automotive vehicle. The discharge lamp assembly includes a lamp housing, a discharge bulb, a starting circuit, a controller unit for controlling operation of the discharge bulb, and associated components. The lamp housing is composed of a front cover including a transparent front lens and a back cover that is detachably connected to the front cover.

The back cover is box-shaped and has a window open to a back side of the lamp housing. The controller unit is a resin-molded single unit that includes components and circuits therein. The controller unit is electrically connected to the starting circuit, to which the discharge bulb is connected, through a cable so that a certain distance between the discharge bulb and the controller unit is secured. Heat transfer from the discharge bulb to the controller unit is suppressed by the distance therebetween.

The controller unit is directly connected to a fringe portion of the window so that heat generated in the controller unit and heat transferred thereto from the discharge bulb are effectively dissipated. The window open to the outside space constitutes a heat-dissipating structure. A heat-dissipating plate may be disposed to close the window, and the controller unit may be mounted on the heat-dissipating plate by adhesive. The heat-dissipating plate may be connected to the fringe of the window with adhesive or connected to the back cover by insert-molding. Heat-dissipating fins may be connected to an outside surface of the heat-dissipating plate to further improve heat-dissipation.

Since the controller unit is directly mounted on the heat-dissipating structure, the heat is effectively dissipated. Since the controller unit is molded with resin, it can be made compact. Since the controller unit is mounted on the back cover that is detachably connected to the front cover of the lamp housing, the controller unit is easily mounted, repaired, replaced or checked.

Other objects and features of the present invention will become more readily apparent from a better understanding of the preferred embodiment described below with reference to the following drawings.

### BRIEF DESCRIPTION OF THE DRAWINGS

FIG. 1 is a cross-sectional view showing a discharge lamp assembly according to the present invention;

FIG. 2 is a perspective and exploded view showing a portion where a starting circuit is disposed in a lamp housing;

FIG. 3 is a cross-sectional view showing a modified form 1 of the discharge lamp assembly of the present invention;

FIG. 4 is a cross-sectional view showing a modified form 2 of the discharge lamp assembly of the present invention;

FIG. 5 is a cross-sectional view showing a modified form 3 of the discharge lamp assembly of the present invention; and

FIG. 6 is a cross-sectional view showing a modified form 4 of the discharge lamp assembly of the present invention.

### DETAILED DESCRIPTION OF THE PREFERRED EMBODIMENT

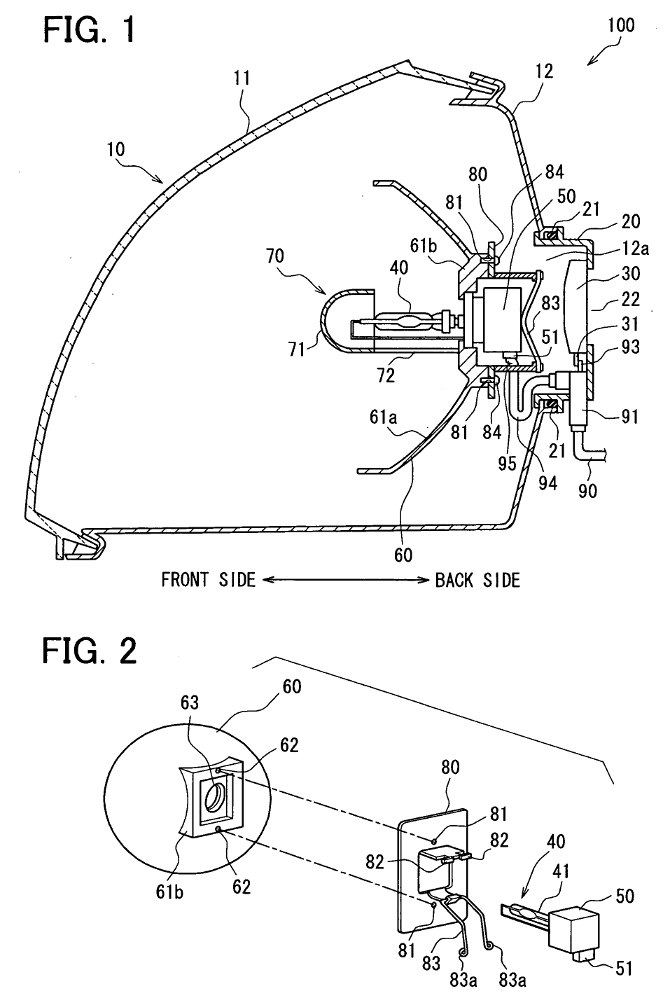

A preferred embodiment of the present invention will be described with reference to FIGS. 1 and 2. In this embodiment, the present invention is applied to a discharge lamp assembly used as a headlamp of an automotive vehicle. A front side and a backside of the headlamp is shown with an arrow in FIG. 1.

The discharge lamp assembly 100 includes: a lamp housing 10 composed of a front cover 12 including a transparent lens 11 and a back cover 20; a controller unit 30; a discharge bulb 40; a starting circuit 50; a reflector 60 having a reflecting surface 61a; a shade 70 intercepting light emitted from the discharge bulb 40 directly to the front side; and a holder plate 80 to which the discharge bulb 40 and the starting circuit 50 are connected. The reflector 60 includes a holder portion 61b to which the holder plate 80 is connected.

The lamp housing 10 is made of resin materials. The front cover 12 has an opening 12a at its backside. The back cover 20 is connected to the opening 12a in a detachable manner, and O-ring 21 is disposed at a junction between the front cover 12 and the back cover 20. The O-ring 21 is disposed in a depression formed around the opening 12a to make the inside of the lamp housing 10 water-tight and to prevent dusts from entering inside.

The starting circuit 50 is connected to a backside of the discharge bulb 40 having a light emitter 41. In front of the discharge bulb 40, the shade 70 is disposed. The shade 70 having a round portion 71 is made of a metallic material. The shade 70 is connected to the holder portion 61b of the reflector 60 via a supporting member 72. Since the light emitted from the discharge bulb 40 directly to the front is intercepted by the shade 70, only the light reflected on the reflecting surface 61a of the reflector 60 is emitted to the front through the transparent lens 11, and thereby the light having a desired distribution pattern is emitted. Electromagnetic noises transmitted frontward are also intercepted by the shade 70.

The reflector 60 is made of a metallic material or a resin material on which a metallic film such as an aluminum film is vapor-deposited. On the front surface of the reflector 60, a reflecting surface 61a is formed. A holder portion 61b is formed at a center portion of the reflector 60. The discharge bulb 40 having a light emitter 41 and the starting circuit 50 are supported by the holder portion 61b. The discharge bulb 40 has to be correctly positioned relative to the reflecting surface 61a to obtain a desired light distribution.

As shown in FIG. 2, the discharge bulb 40 is connected to the starting circuit 50, and the starting circuit 50 is positioned to abut a stopper 63 formed on the holder portion 61b. Thus, the discharge valve 40 is correctly positioned relative to the reflecting surface 61a. A holder plate 80 for mounting the starting circuit 50 on the holder portion 61b is fixed to the holder portion 61b by a pair of screws 80 screwed into crew holes 62 formed in the holder portion 61b through holes 81 formed in the holder plate 80. The holder plate 80 is made of a resin or metallic material.

A spring member 83, slightly bent in its middle portion, is rotatably supported by a hook formed on the holder plate 80. The starting circuit 50 is pushed against the stopper 63 of the holder portion 61b by the spring member 83. The ends 83a of the spring member 83 engage with the engaging portions 82 formed on the holder plate 80, thereby firmly pushing the starting circuit 50 against the stopper 63.

The starting circuit 50 powered by an on-board battery generates a high voltage that is necessary for starting the discharge bulb 40. A connector 51 of the starting circuit 50 is connected to outer connector 91 through a cable 94. The outer connector 91 is connected to the on-board battery through a lead wire 90. A terminal 93 of the outer connector 91 is connected to a terminal 31 of the controller unit 30. Thus, the starting circuit 50 and the controller unit 30 are powered by the on-board battery.

The controller unit 30 for controlling operation of the discharge bulb 40 includes a converter for boosting a voltage supplied from the battery and an inverter for obtaining an alternating voltage from the direct current voltage of the battery. Components and elements forming the inverter and the converter are mounted on a printed board and molded with resin into a single unit. By forming the controller unit 30 with resin molding, the controller unit 30 can be made small in size. If the controller unit 30 is formed by containing the components and elements in a casing, the casing have to be filled with a filler such as gel-type insulator. This makes the controller large in size. In addition, the controller unit 30 made by resin-molding can be manufactured at a lower cost than by containing in a casing.

Now, the back cover 20 on which the controller unit 30 is mounted will be described. The back cover 20 is formed in a box-shape including a window 22. The controller unit 30 is connected with adhesive to a mounting surface forming a fringe of the window 22. Thus, a back surface of the controller unit 30 faces outside so that heat generated in the controller unit 30 and heat transferred from the discharge bulb 40 are easily dissipated. In this manner, the heat of the controller unit 30 is effectively dissipated even the controller unit 30 is molded with resin.

A certain distance is secured between the discharge bulb 40 and the controller unit 30 by disposing the starting circuit 50 therebetween and by connecting the discharge bulb 40 and the controller unit 30 through the cable 94. Therefore, heat transfer from the discharge bulb 40 to the controller unit 30 is suppressed. The controller unit 30 is mounted on the back cover 20 which is detachable from the front cover 12. Therefore, the controller unit 30 can be easily separated from the front cover 12 together with the back cover 20 for checking its operation, replacing or repairing the controller unit 30. In addition, the discharge bulb 40 and the starting circuit 50 are easily checked or replaced because the back cover 20 is detachably connected to the front cover 12.

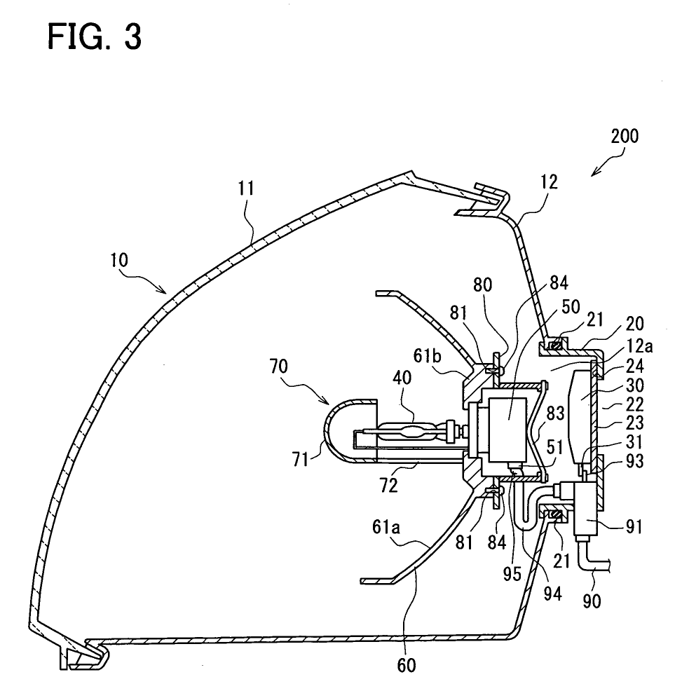

The embodiment of the present invention described above may be variously modified. FIG. 3 shows a discharge lamp assembly 200 as a modified form 1 of the present invention. In this modified form 1, a heat-dissipating plate 23 is additionally used. The controller unit 30 is connected to the heat-dissipating plate 23 with adhesive, and the connecting portion 24 of the heat-dissipating plate 23 is connected to the fringe portion of the window 22. Since the heat-dissipating plate 23 faces outside, the heat can be more easily dissipated. Other structures and functions are the same as those of the embodiment described above.

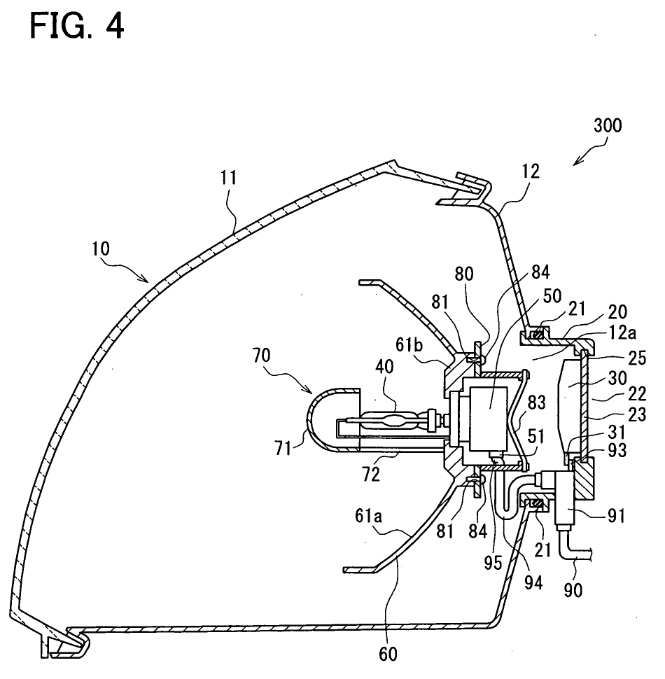

FIG. 4 shows a discharge lamp assembly 300 as a modified form 2 of the present invention. In this modified form 2, the heat-dissipating plate 23 is molded together with the back cover 20, so that the dissipating plate 23 is firmly connected to a depression 25 of the back cover 20. In this manner, it is not necessary to connect the dissipating plate 23 to the back cover 20 with adhesive. Other structures and functions are the same as those of the modified form 2.

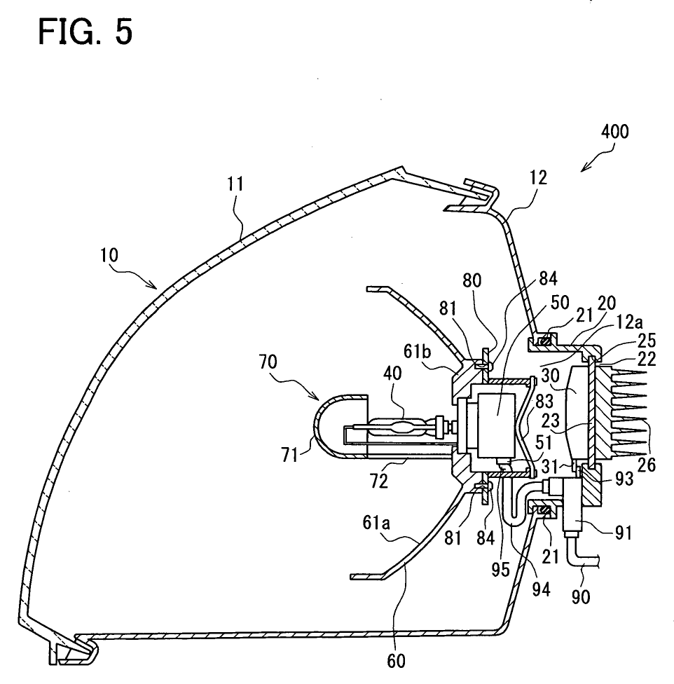

FIG. 5 shows a discharge lamp assembly 400 as a modified form 3 of the present invention. In this modified form 3, heat-dissipating fins 26 are connected (e.g., with adhesive) to the heat-dissipating plate 23 which is insert-molded in the back cover 20. In this manner, heat dissipation is further improved. Other structures and functions are the same as those of the modified form 2.

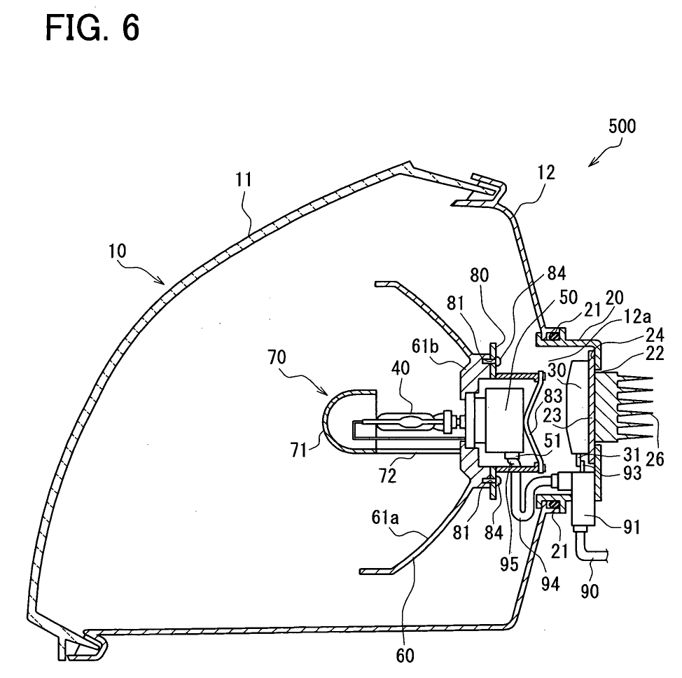

FIG. 6 shows a discharge lamp assembly 500 as a modified form 4 of the present invention. In this modified form 4, the heat-dissipating fins 26 are connected to the heat-dissipating plate 23 which is connected to the fringe portion of the window 22 with adhesive. Other structures and functions are the same as those of the modified form 3 described above.

In summary, a heat-dissipating structure is formed in the detachable back cover 20 on which the controller unit 30 is mounted. The heat-dissipating structure may be in various forms, such as a window 22, a heat-dissipating plate 23 connected to the fringe portion of the window 22, a heat-dissipating plate 23 insert-molded in the back cover 20, or a heat-dissipating plate on which heat-dissipating fins 26 are connected. The heat is easily dissipated from the controller unit 30 because of the heat-dissipating structure. Although the present invention is applied to the automotive headlamp in the embodiment described above including the modified forms, it is, of course, possible to apply the present invention to other devices or equipment.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A discharge lamp assembly comprising:
a lamp housing having a heat-dissipating structure;
a discharge bulb contained in the lamp housing; and
a controller unit, molded with resin, for controlling operation of the discharge bulb, the controller unit being mounted directly on the heat-dissipating structure.

2. The discharge lamp assembly as in claim 1, wherein the lamp housing includes a detachable back cover, and the heat-dissipating structure is included in the back cover.

3. The discharge lamp assembly as in claim 1, wherein the discharge bulb is electrically connected to the controller unit through a cable.

4. The discharge lamp assembly as in claim 1, wherein the heat-dissipating structure includes a window open to an outside of the lamp housing.

5. The discharge lamp assembly as in claim 4, wherein a heat-dissipating plate is disposed to close the window.

6. The discharge lamp assembly as in claim 5, wherein heat-dissipating fins are connected to the heat-dissipating plate.
